(19) United States
(12) Patent Application Publication
(10) Pub. No.: US 2021/0405349 A1
(43) Pub. Date: Dec. 30, 2021

(54) ACTUATION OF A SCANNING MIRROR USING AN ELASTIC COUPLING

(71) Applicant: Blickfeld GmbH, Munich (DE)

(72) Inventors: Markus RAUSCHER, Munich (DE); Jan KUYPERS, Munich (DE)

(21) Appl. No.: 17/289,672

(22) PCT Filed: May 29, 2019
(86) PCT No.: PCT/EP2019/064043

§ 371 Date: Apr. 28, 2021

(30) Foreign Application Priority Data
May 29, 2018 (DE) 10 2018 112 809.6

(51) Int. Cl. G02B 26/08; G02B 26/10

(52) U.S. Cl. CPC G02B 26/0858; G02B 26/0825; G02B 26/105

(57) ABSTRACT

A scan unit (100) includes a base (141) and an elastic mount (111) having a first end (111A) and a second end (111B). The first end (111A) is coupled to the base (141), the second end (111B) being configured to couple to a mirror (150). The scan unit (100) also includes at least one interface element (146) configured to couple to one or more actuators (172, 310, 320). The scan unit (100) further includes at least one elastic coupling (400-404) arranged in-between the base (141) and the at least one interface element (146) and configured to deflect the base (141) upon actuation of the one or more actuators (172, 310, 320). The at least one elastic coupling (400-404) is integrally formed with at least a part (141A) of the base (141) and the at least one interface element (146).

### BACKGROUND

Mirrors for scanning light (scanning mirrors) are employed in various use cases. One example use case is distance measurement using light (light detection and ranging; LIDAR; sometimes also referred to as laser ranging or LADAR). Pulsed or continuous-wave laser light is transmitted and, after reflection at an object, detected. For providing a lateral resolution, the light is scanned using a movable scanning mirror.

In various applications, it is desirable to implement a large deflection of the scanning mirror. Thereby, large scanning angles can be obtained. A large field-of-view (FOV) of a LIDAR application can be achieved.

Various conventional techniques of moving scanning mirrors use electrostatic actuators, see, e.g., US20120075685A1. The achievable deflection of the scanning mirror is limited in such reference implementations. To achieve larger deflections, an evacuated package is sometimes employed, which is costly and reduces a durability.

DE 10 2016 011 647 A1 describes techniques of moving a scanning mirror using bending piezo actuators.

### SUMMARY

A need exists for advanced techniques of moving a scanning mirror. Specifically, a need exists for techniques which facilitate moving a scanning mirror using a simple, yet durable design of the corresponding actuator.

This need is met by the features of the independent claims. The features of the dependent claims define embodiments.

According to examples, a scan unit includes a base and an elastic mount. The elastic mount has a first end and a second end. The first end is coupled to the base. The second end is configured to couple to a mirror. The scan unit also includes at least one interface element which is configured to couple to one or more actuators. The scan unit also includes at least one elastic coupling. The at least one elastic coupling is arranged in-between the base and the at least one interface element and configured to deflect the base upon actuation of the one or more actuators. The at least one elastic coupling is integrally formed with at least a part of the base and the at least one interface element.

According to examples, a method includes controlling at least one piezoelectric actuator to resonantly or semi-resonantly deflect a elastic mount of a scanning mirror by non-resonantly deflecting at least one elastic coupling.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a scan system including a scan unit according to various examples.

FIG. 2 is a perspective view of a scan unit including a elastic mount of a mirror, wherein the elastic mount includes torsional springs according to various examples.

FIG. 3 is a schematic illustration of bending piezoelectric actuators coupled to a scan unit to excite a torsional eigenmode associated with the elastic mount according to various examples.

FIG. 4 is a schematic illustration of bending piezoelectric actuators coupled to a scan unit to excite a torsional eigenmode associated with the elastic mount according to various examples.

FIG. 5 is a schematic illustration of bending piezoelectric actuators coupled to a scan unit to excite a torsional eigenmode associated with the elastic mount according to various examples, wherein FIG. 5 illustrates a rest state.

FIG. 6 is a schematic illustration of bending piezoelectric actuators coupled to a scan unit to excite a torsional eigenmode associated with the elastic mount according to various examples, wherein FIG. 6 illustrates actuated states.

FIG. 7 is a cross-sectional view of FIG. 3 in a rest state of the bending piezoelectric actuators according to various examples.

FIG. 8 is a cross-sectional view of FIG. 3 in an out-of-phase actuated state of the bending piezoelectric actuators according to various examples.

FIG. 9 is a cross-sectional view of FIG. 3 in an in-phase actuated state of the bending piezoelectric actuators according to various examples.

FIG. 10 schematically illustrates elastic couplings in-between the bending piezoelectric actuators of FIGS. 4-9 and the elastic mount according to various examples.

FIG. 11 is a perspective view of FIG. 10 according to various examples.

FIG. 12 is a perspective view of FIG. 10 according to various examples.

FIG. 13 is a flowchart of a method according to various examples.

FIG. 14 is a schematic illustration of elastic couplings according to various examples.

FIG. 15 is a schematic illustration of elastic couplings according to various examples.

FIG. 16 is a schematic illustration of elastic couplings according to various examples.

### DETAILED DESCRIPTION OF EMBODIMENTS

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, techniques of using a mirror to steer light are described. The mirror may be moved by reversible deformation at least one elastic spring. Tailored deflection of the mirror facilitates steering of the light. The at least one spring may implement a elastic mount. The spring can deform reversibly, i.e., without structural damage to the material.

For example, the techniques described herein may facilitate 1-D or 2-D scanning of light. Scanning of light can correspond to repetitively redirecting light using different transmission angles. For this, the light can be steered by one or more mirrors, sometimes referred to as scanning mirrors. Larger scanning areas correspond to larger changes in the transmission angles; larger changes in the transmission angles can be achieved by larger deflection of the scanning mirror. Thereby, a FOV of the scanning can be increased.

It is possible to implement transmission angles by deflecting the scanning mirror in accordance with one or more degrees of freedom of motion of the mirror. For example, the mirror may be rotated, tilted, shifted, etc. As a general rule, the various techniques described herein may rely on various degrees of freedom for the motion of the mirror. Examples include transversal motion or rotation.

According to some examples, resonant or semi-resonant deflection of the elastic mount of the scanning mirror is possible. The at least one spring of the elastic mount may be resonantly or semi-resonantly actuated. Thereby, large changes in the transmission angles can be achieved. Large scanning areas can be implemented.

As a general rule, the techniques described herein may find application in various use cases. Example use cases include, but are not limited to: LIDAR with lateral resolution, spectrometers, projectors, endoscopes, etc. Hereinafter, for sake of brevity, reference is primarily made to LIDAR use cases; similar techniques may be readily employed for other use cases.

The scanning mirror and the elastic mount can be part of a scan unit. A scan system may include the scan unit, a light source configured to emit light to be scanned, and/or a detector configured to receive reflected light. The scan system can also include one or more actuators to actuate the elastic mount, to thereby deflect the scanning mirror.

According to various examples, it would be possible to scan laser light. For example, coherent or incoherent laser light can be used. Polarized or non-polarized laser light may be used. Pulsed laser light may be used. For example, short laser pulses having a width in the range of picoseconds or nanoseconds may be used. For example, a pulse duration in the range of 0.5-3 nanoseconds may be used. The laser light can have a wavelength in the range of 700-1800 nanometers, specifically of 1550 nanometers or 950 nanometers. For the sake of simplicity, hereinafter, reference is primarily made to laser light; the various described examples can be readily applied to scanning light from non-laser light sources, e.g., RGB light sources, light-emitting diodes, etc.

As a general rule, in the various examples described herein, one or more springs may be used to implement the elastic mount. For sake of simplicity, hereinafter, reference is made to implementations where the elastic mount includes multiple springs, but respective techniques may be readily applied to scenarios where only a single spring is used.

Since the elastic mount is used to deflect the scanning mirror, the spring(s) of the elastic mount may be referred to as mirror spring(s).

The mirror springs can have a form-induced elasticity and/or a material-induced elasticity; and may, hence, not be formed rigidly with respect to typical forces applied to scan light. The mirror may be attached to a movable end of the elastic mount. By torsion and/or transversal motion of the springs, rotation and/or tilt of the mirror can result. Generally, a position and/or orientation (pose) of the mirror is changed, i.e., the mirror is deflected, by the deformation of the elastic mount of the mirror.

The employed mirror springs of the elastic mount can have a length in the range of 2 millimeters-8 millimeters, e.g., in the range of 3 millimeters-6 millimeters. The mirror springs of the elastic mount can be formed straight in a rest state without deflection. A cross-sectional diameter of the springs can be in the range of 50 micrometers-250 micrometers. It would be possible that the elastic mount and/or the mirror is formed from Silicon.

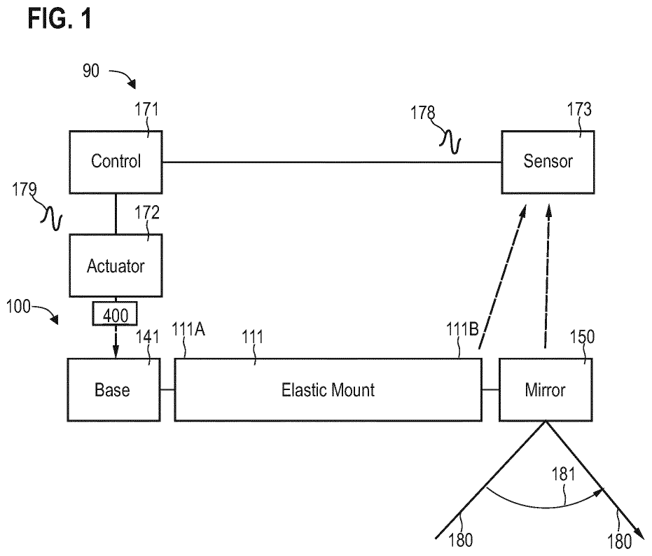

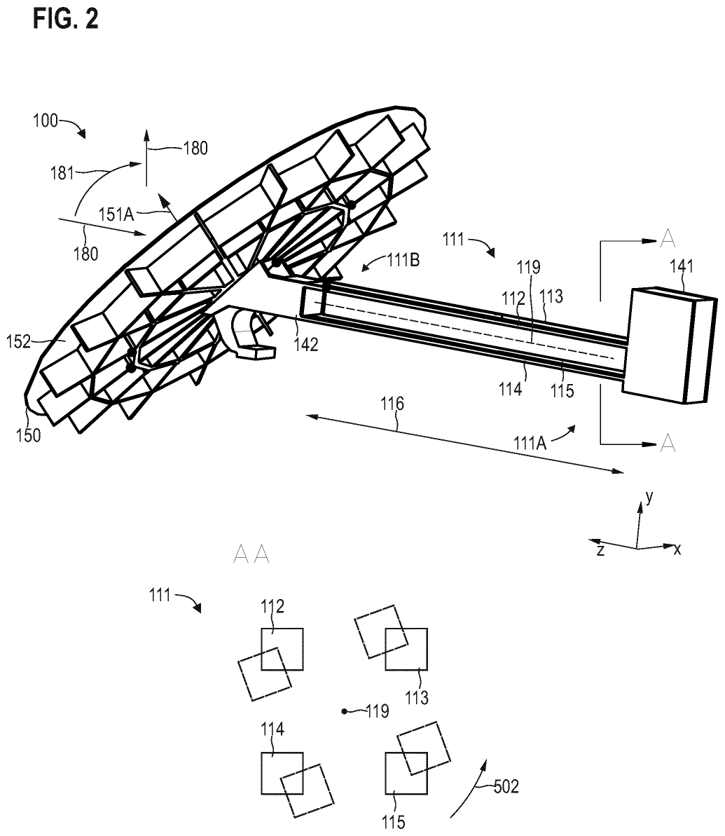

In the various examples described herein, it would be possible that the elastic mount extends away from an outer circumference of a reflective area of the mirror. For example, the mirror springs of the elastic mount could extend in a plane defined by the reflective area of the scanning mirror or in a parallel plane thereto (in-plane design). See, e.g., WO2018055513: FIG. B4C; or US20100296146A1: FIG. 1A; or U.S. Pat. No. 8,729,770B1: FIG. 2. In alternative examples, it would be possible that the elastic mount does not extend in the plane defined by the reflective area; but rather encloses an angle, e.g., in the range of 30°-90°, optionally 45°. As a general rule, it would be possible that the elastic mount extends away from a backside of the mirror (out-of-plane design). Periscope-type scanning would be possible. See, e.g., DE 10 2016 013 227 A1: FIG. 2.

In various techniques it would be possible that the elastic mount and/or the mirror are fabricated using techniques of microelectromechanical systems (MEMS) and/or micromachining. As such, the mirror may be referred to as micromirror. For example, appropriate lithography process steps and/or etching process steps can be applied to a wafer to form the elastic mount and/or the mirror. For example, reactive ion beam etching could be implemented. A Silicon-on-Insulator wafer could be used.

Hereinafter, techniques are described which facilitate actuation of the elastic mount to deflect the scanning mirror. Specifically, techniques are described which facilitate large deflection of the scanning mirror, thereby facilitating large scanning areas of the associated scanning. Various examples relate a design of the corresponding actuator which facilitates automated production, e.g., using MEMS techniques. Various examples enable a robust design that can withstand adverse environmental influences such as shock, etc. Further, according to various examples, an integrated design of the scan unit becomes possible which facilitates interfacing one or more actuators in a robust manner. For example, at least one interface element configured to couple the scan unit to one or more piezoelectric actuators can be integrally formed with the elastic mount, e.g., using MEMS techniques and/or micromachining.

According to examples, this is achieved by a scan unit that includes a base and a elastic mount. The elastic mount has a first end and a second end. The first end is coupled to the base. The second end is configured to couple to a mirror. The scan unit also includes at least one interface element which is configured to couple to one or more actuators. The scan unit also includes at least one elastic coupling which is arranged in-between the base and the at least one interface element. The at least one elastic coupling is configured to deflect the base upon actuation of the one or more actuators. The at least one elastic coupling can be integrally formed with the at least one interface element and/or at least a part of the base.

MEMS processing and/or micromachining becomes possible to fabricate the elastic coupling. Further, wear-out of the elastic coupling between the at least one interface element and the base can be avoided by using, e.g., torsion of or transversal deflection of one or more springs of the elastic coupling that may have a well-defined stress resistance.

For example, the at least one elastic coupling can be configured to translate a linear stroke of the one or more actuators into a rotation of the base. As such, the at least one elastic coupling may implement hinge functionality.

It would be possible that the at least one elastic coupling includes one or more torsional springs. For example, each one of the at least one elastic coupling may include one or more torsional springs. To this end, the elastic coupling may implement a torsional coupling. To implement torsional springs, a geometric shape of the torsional springs may be such that flexure of the torsional springs is associated with a larger spring stiffness than torsion of the torsional springs. For example, the one or more torsional springs may be rod-shaped. For example, a length of the one or more torsional springs of each one of the at least one elastic coupling may be in the range of 2 mm-5 mm; the width of each one of the torsional springs may be much smaller, e.g., in the range of 20 μm-250 μm. For example, a ratio between a width of the one or more torsional springs and a length of the one or more torsional springs of each one of the at least one elastic coupling may be in the range of 1:20 to 1:100, optionally in the range of 1:30 to 1:50.

It would be possible that the torsional springs are fabricated from Silicon, e.g., using MEMS techniques and/or micromachining. For example, a longitudinal axis of the one or more torsional springs may be aligned with a <110> or <100> direction of crystalline Silicon.

FIG. 1 schematically illustrates aspects with respect to a scan system 90. The scan system 90 may include a light source, e.g., a laser diode, and a detector (not shown in FIG. 1).

The scan system 90 includes a scan unit 100. The scan unit 100 includes a elastic mount 111 of a mirror 150. The mirror 150 is configured to steer light 180, thereby defining a transmission angle 181. A base 141 associated with the elastic mount 111 is at a first end 111A of the elastic mount 111 which is opposite from the second end 111B at which the mirror 150 can be attached.

FIG. 1 also illustrates an actuator 172 which is configured to exert a force on the elastic mount 111 via the base 141 upon actuation, to thereby trigger a reversible deformation of the elastic mount 111. This deformation results in a deflection of the mirror 150, i.e., a change of the pose of the mirror 150, which, in turn, results in a change of the transmission angle 181.

The actuator 172 can be implemented using one or more piezoelectric actuators, specifically bending piezoelectric actuators. Other alternatives include magnetic drives.

The operation of the actuator 172 is controlled by a control signal 179 which is output by a control device 171. The control signal 179 can include a one or more frequency components. The one or more frequency components can be appropriately selected in order to facilitate resonant or semi-resonant deflection of the elastic mount 111. The one or more frequency components, in other words, can be matched to one or more eigenmodes of the elastic mount 111 or, more specifically, of a mass-spring system formed by the mirror 150 and the elastic mount 111.

The control device 171, in the example of FIG. 1, is configured to determine the control signal 179 based on a measurement signal 178 received from a sensor 173. The sensor 173 is configured to provide the measurement signal 178 which is indicative of the pose of the mirror 150.

As illustrated in FIG. 1, the actuator 172 is coupled with the base 141 via a coupling 400. The force exerted by the actuator 172 onto the base 141 to deflect the base 141 is transferred via the coupling 400; then, by deflection of the base 141, the elastic mount 111 is actuated. The elastic coupling 400 can thus provide a transmission functionality between deflection of the actuator 172 and deflection of the base 141.

According to various examples described herein, the coupling 400 is a elastic coupling. Hence, the elastic coupling 400 is configured to provide reversible, elastic deformation. For this purpose, according to various examples, the elastic coupling 400 includes one or more springs, e.g., torsional springs or other types of springs (not illustrated in FIG. 1).

FIG. 2 illustrates aspects with respect to the scan unit 100. FIG. 2 is a perspective view of an example structural implementation of the scan unit 100. For example, the scan unit 100 could be fabricated from Silicon, e.g., using MEMS techniques and/or micromachining.

In the example of FIG. 2, the scan unit 100 includes a mirror 150. The mirror 150 has a reflective front side as a reflective area (obstructed from view in FIG. 2); as well as an opposite backside 152. The mirror 150 has a backside structure including fins and cavities. Thereby, the mass moment of inertia of the mirror 150 can be tailored by appropriate geometrical implementation of the backside structure. The eigenfrequencies of the various motional degrees of freedom of the elastic mount 111—including torsion and transversal deflection—can thereby be adjusted.

In the example of FIG. 2, four torsional mirror springs 111-114 of the elastic mount 111 extend away from the backside 152 of the mirror, towards the base 141 (the elastic coupling 400 is not illustrated in FIG. 2). A longitudinal center axis 119 is illustrated; a length 116 is illustrated. A spacer 142 is attached to the backside 152 of the mirror and provides a coupling between the mirror 150 and the elastic mount 111.

As a general rule, while in FIG. 2 an out-of-plane arrangement of the elastic mount 111 and the mirror 150 is illustrated, in would also be possible to implement an in-plane arrangement of the elastic mount 111 and the mirror 150: here, the mirror spring(s) of the elastic mount 111 can extend in one or more planes coincident with or parallel to the plane of the reflective area of the mirror 150.

The elastic mount 111 extends away from a center of the backside 152 of the mirror 150. Thereby, an imbalance is avoided when providing a torsion 502 of the elastic mount (compare inset of FIG. 2 which is a cross-sectional view along the line A-A).

In the example of FIG. 2, the springs 112-115 are arranged with a fourfold rotational symmetry with respect to the center axis 119 of the elastic mount 111. Specifically, the springs 112-115 are arranged at the edges of a (virtual) square that is arranged in the drawing plane of the inset of FIG. 2. In the inset of FIG. 2, the full lines indicate the position of the spring elements in the rest position; while the dashed lines indicate the positions of the spring elements 111-114 and presence of elastic deformation by the torsion 502.

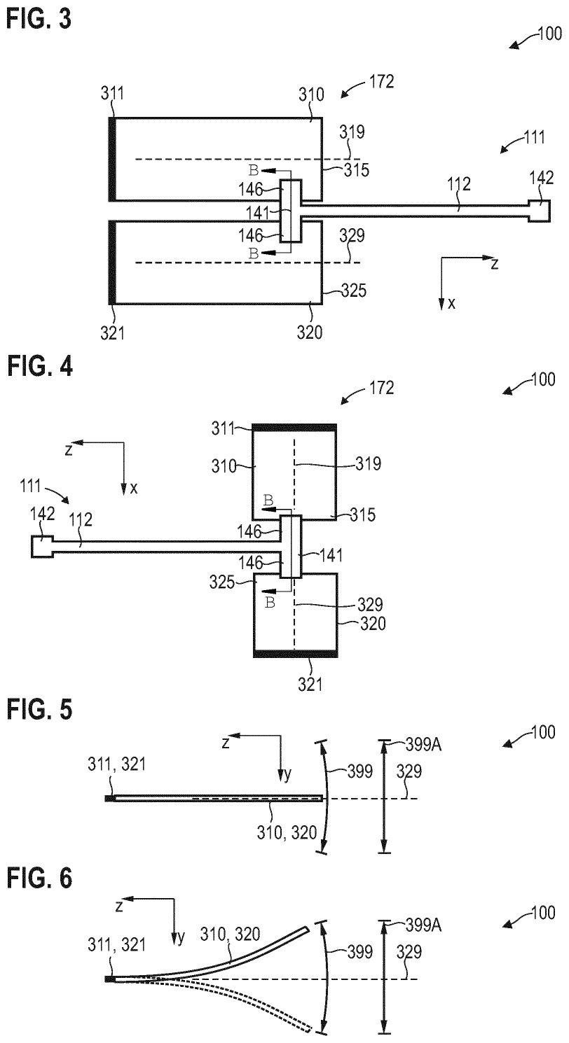

FIGS. 3-6 illustrate aspects with respect to the actuator 172. While in the example of FIGS. 3-5, the scan unit 100 only includes a single spring 112, generally, it would be possible that the scan unit 100 includes multiple spring elements, e.g., as illustrated in connection with FIG. 2. Further, for sake of simplicity, in FIGS. 3-5, the mirror is not illustrated, but could be attached to the spacer 142 in an out-of-plane arrangement (cf. FIG. 2) or an in-plane arrangement.

The actuator 172 is coupled with the base 141 next to the respective end 111A of the elastic mount 111—while the mirror is coupled to the opposite end 111B of the elastic mount 111 (also cf. FIGS. 1 and 2).

In the examples of FIGS. 3-5, the actuator 172 is implemented by a pair of bending piezoelectric actuators 310, 320. The bending piezoelectric actuators 310, 320 are coupled to interface elements 146 of the base 141 of the scan unit 100. For example, an adhesive may be used to couple the bending piezoelectric actuators 310, 320 to the interface elements. In the example of FIGS. 3-5, two interface elements 146—roughly shaped as wings of the base 141—are arranged on opposite sides of the base 146.

As a general rule, instead of using a pair of bending piezoelectric actuators 310, 320, it would be possible to only use a single bending piezo (not illustrated). Then, one of the interface elements 146 may be fixed, e.g., with respect to a reference coordinate system defined by the housing, etc.

FIG. 5 is a side view of the bending piezoelectric actuators 310, 320. FIG. 5 illustrates the bending piezoelectric actuators 310, 320 in their rest position, e.g., if there is the control signal 179 having zero level being applied. FIG. 6 illustrates the reversal states of the deflection 399 of the bending piezoelectric actuators 310, 320.

Referring again to FIG. 3: for example, it would be possible that the fixed end 311, 321 forms a non-elastic coupling between the bending piezoelectric actuators 310, 320 and a housing of the scan system 90 (not illustrated in FIGS. 3-5).

In the example of FIG. 3, the bending piezoelectric actuators 310, 320 are aligned essentially in parallel with each other. Also, a head-to-tail arrangement of the bending piezoelectric actuators 310, 320 would be possible; or, generally, an arbitrary orientation in between the longitudinal axis 319, 329. The example of FIG. 4 generally corresponds to the example of FIG. 3, wherein, in FIG. 4, another arrangement of the bending piezoelectric actuators 310, 320 with respect to the elastic mount 111 is illustrated (rotated by 90° in their plane if compared to FIG. 3).

By applying a voltage to electrical contacts of the bending piezoelectric actuators 310, 320—using a non-zero level of the control signal 179 —, the bending piezoelectric actuators 310, 320 are bent along the longitudinal axis 319. For this, the bending piezoelectric actuators 310, 320 typically include a layer stack of different materials (not illustrated in FIG. 3-5). Thereby, a movable end 315, 325 of the bending piezoelectric actuators 310, 320 is displaced with respect to a fixed end 311, 321 perpendicular to the respective longitudinal axis 319, 329 (in the example of FIG. 3, this deflection is oriented perpendicular to the drawing plane). This deflection 399 of the bending piezoelectric actuators 310, 320 is illustrated in FIG. 5. In FIG. 5, the peak-to-peak stroke length 399A is illustrated. The bending piezoelectric actuators 310, 320 perform a quasi-linear motion along the y-direction.

As a general rule, other kinds and types of actuators may be used that are configured to perform a quasi-linear motion.

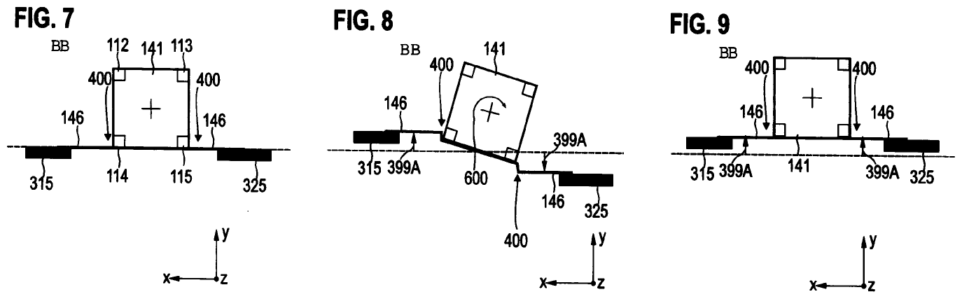

By tailoring the deflection 399 of the bending piezoelectric actuators 310, 320, it is possible to deflect the elastic mount 111, by deflecting the base 141 via the elastic coupling 400 (not illustrated in FIGS. 3-5). This function of the actuator 172 is explained with respect to FIGS. 7-9.

FIGS. 7-9 illustrate aspects with respect to deflecting the base 141. FIGS. 7-9 are cross-sectional views along the line B-B in FIG. 3 or FIG. 4.

Generally, by deflecting the base 141, the elastic mount 111 can be actuated. For example, the base 141 can be deflected periodically at one or more frequencies which resonantly or semi-resonantly excite a torsional eigenmode of the mass-spring system formed by the elastic mount 111 and the mirror 150. Alternatively or additionally, the base 141 can be deflected periodically at one or more frequencies which resonantly or semi-resonantly excite a transversal eigenmode of the mass-spring system.

FIG. 7 illustrates the bending piezoelectric actuators 310, 320 in their rest position. The base 141 is not deflected.

As illustrated in FIG. 7, in the rest position, the interface elements 146 and the elastic couplings 400 are arranged in a common plane. They can be integrally formed, e.g., with at least a part of the base 141. For example, the interface elements 146, the elastic mount 400, and at least a part of the base 141 may be produced in a MEMS process or a micromachining process from a common wafer.

In the example of FIG. 7, the base 141 has a thickness perpendicular to the plane

FIG. 8 illustrates an out-of-phase deflection of the bending piezoelectric actuators 310, 320 which result in a rotational motion of the base 141 (the axis of rotation 600 is oriented perpendicular in the drawing plane of FIG. 8). Such a rotational motion of the base 141 can effectively couple energy into the torsional eigenmode of the mass-spring system formed by the mirror 150 and the elastic mount 111 which can thereby be excited.

FIG. 9 illustrates an in-phase deflection of the bending piezoelectric actuators 310, 320 which results in a translational motion of the base 141 (the axis of motion is oriented up-down in the drawing plane of FIG. 9). Such a translational motion of the base 141 can effectively couple energy into the transversal eigenmode of the mass-spring system formed by the elastic mount 111 and the mirror 150.

According to the various examples described herein, it is possible to excite the torsional eigenmode of the elastic mount 111 and/or the transversal eigenmode of the mass-spring system formed by the elastic mount 111 and the mirror 150. Resonant or semi-resonant scanning of the mirror 150 is thereby possible.

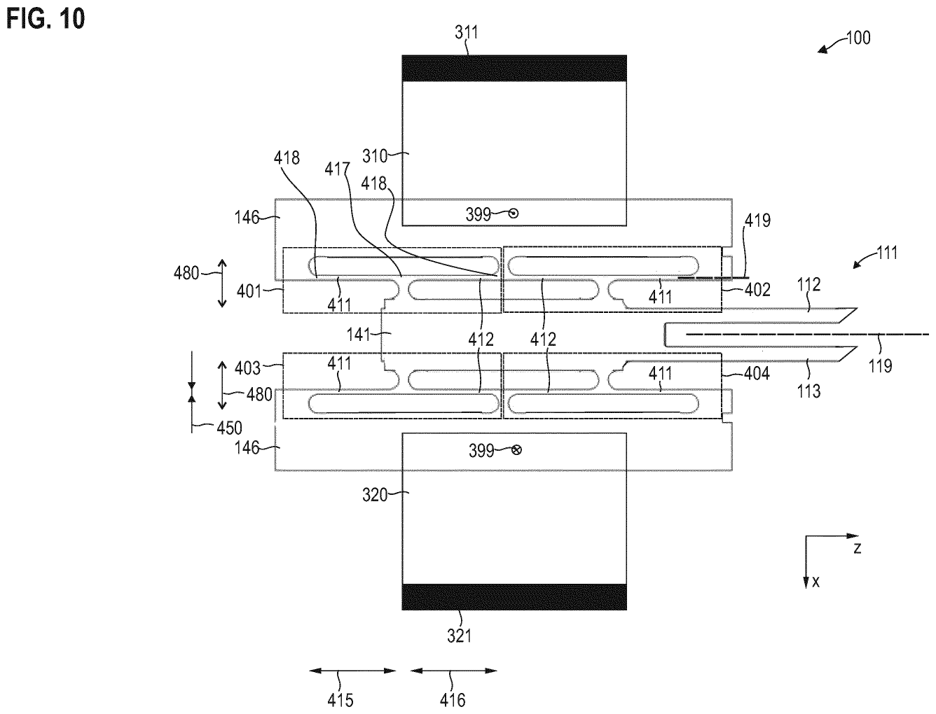

As illustrated in FIGS. 3-9, the force exerted by the bending piezoelectric actuators 310, 320 to move the base 141 is transferred via the interface elements 146. To accommodate for the rotation of the base 141, elastic of the coupling 400 between the interface elements 146 and the base 141 is provided for (cf. FIG. 8). The deflection of the coupling 400 may be non-resonant. Hence, a spring stiffness of the elastic coupling 400 may be different from a spring stiffness of the elastic mount 111. Next, with respect to FIG. 10, an example implementation of such an elastic coupling 400 by a plurality of torsional couplings is illustrated.

FIG. 10 illustrates aspects with respect to torsional couplings 401-404 between the interface elements 146. FIG. 10 generally corresponds to the scenario of FIG. 4, wherein FIG. 10 provides a larger level of detail.

In FIG. 10, four torsion couplings 401-404 implement the elastic coupling 400.

In FIG. 10, a gap 480 is formed in-between the interface elements 146 and the base 141. Outer edges of the interface elements 146 are aligned with outer edges of the base 141. In FIG. 10, the torsional couplings 401-404 cross the gap 480.

The torsional couplings 401-404 (highlighted by the dotted lines in FIG. 10) are arranged in-between the base 141 and the interface elements 146. The torsional couplings 401-404, the respective part of the base 141, and the interface elements 146 are integrally formed within a common plane (in the rest position). The torsional couplings 401-404 are configured to deflect the base 141 upon actuation of the bending piezoelectric actuators 310, 320. Specifically, the torsional couplings 401-404 are configured to facilitate the rotation 600 of the base 141, to thereby excite the torsional eigenmode of the mass-spring system formed by the elastic mount 111 and the mirror 150.

Thus, the torsional couplings 401-404 can be said to implement hinge functionality for the base 141.

In the example of FIG. 10, the longitudinal axis 119 of the elastic mount 111 is aligned with the longitudinal axis 419 of the torsional springs 411, 412. In other words, the torsional axis of the elastic mount 111 is aligned with the torsional axis of the torsional couplings 401-404 and the axis of the rotation 600 of the base 141. This allows to efficiently excite the torsional eigenmode of the mass-spring system formed by the elastic mount 111 and the mirror 150. As a general rule, an angle of ±20° may be enclosed by the longitudinal axis 119 of the elastic mount 111 and the longitudinal axis 419 of the torsional springs 411, 412.

In the example of FIG. 10, two torsional couplings 401-404 are provided per interface element 146. For example, the torsional couplings 401, 402 are arranged in between the base 141 and the upper interface element 146 associated with the bending piezoelectric actuator 310; and the torsional couplings 403, 404 are arranged in between the base 141 and the lower interface element 146 associated with the bending piezoelectric actuator 320.

As a general rule, it would be possible to provide only a single torsional coupling per bending piezoelectric actuator 310, 320; also, it would be possible to provide more than two torsional couplings per bending piezoelectric actuator 310, 320.

In the example of FIG. 10, each torsional coupling 401-404 includes two torsional springs 411, 412. T-shaped torsional couplings 401-404 are thereby implemented. These torsional couplings may be referred to as clamped-clamped beams with a center connection to the base 141. In detail, the torsional springs 411, 412 of the various torsional couplings 401-404 have a common first end 417 that is coupled to the base 141; and each have separate second ends 418 coupled to the respective interface element 146 (for sake of simplicity, these ends 417, 418 are only illustrated for the torsional springs 411, 412 of the torsional coupling 401 in FIG. 10).

By such an implementation, the overall length of torsional spring 411, 412 is kept small. This can be helpful to implement a large stiffness for transversal deformation of the torsional springs 411, 412. Thereby, unwanted transversal deflection of the torsional springs 411, 412 can be avoided or reduced.

While in FIG. 10 each torsional coupling 401-404 includes two torsional springs 411, 412, as a general rule, it would be possible that each torsional coupling 401-404 includes only a single torsional spring or includes more than two torsional springs (not illustrated in FIG. 10).

As illustrated in FIG. 10, the torsional springs 411, 412 are arranged within and aligned with the gaps 480 between the base 141 and the interface elements 146. Thereby, the width of the gaps 480 (along x-direction)—or, in other words, the distance between the interface elements 146 and the base 141—can be dimensioned small. This provides for a significant stiffness of the torsional couplings 401-404 with respect to unwanted degrees of freedom. The rotation 600 of the base 141 upon out-of-phase actuation of the bending piezoelectric actuators 310, 320 (cf. FIG. 8) is achieved; while, e.g., motion of the base 141 along the z-direction is suppressed.

To avoid excessive stress or strain in the torsional couplings 401-404—potentially leading to material breakage —, the torsional springs 411, 412 can be dimensioned to have a certain length 415, 416. For example, the length 415 of the torsional springs 411 and the length 416 of the torsional springs 412 can be at least 100% of the width of the gaps 480 (in x-direction), optionally at least 150% of the width, further optionally at least 200% of the width.

Also, as a general rule, the length 415, 416 of the torsional springs 411, 412 of the torsional couplings 401-404 can be significantly smaller than the length 116 of the mirror springs 112-115 (cf. FIG. 2). For example, the longest length 415, 416 of the torsional springs 411, 412 can be in the range of 1-3 mm. For example, the aggregate length 415, 416 of the torsional springs 411, 412 of a given coupling 401-404 can be in the range of 3-4 mm.

For example, the longest length 415, 416 of any one of the torsional springs 411, 412 of the torsional couplings 401-404 can smaller than 40% of the longest length 116 of any one of the mirror springs 112-115, optionally smaller than 20%, further optionally smaller than 10%. For example, the length 415, 416 of the one or more torsional springs 411, 412 of the at least one coupling may be in the range of 20%-80% of the length 116 of the one or more torsional mirror springs 111-115 of the elastic mount 111, optionally in the range of 30%-50%. It is possible to tailor the spring stiffness via the respective length. Thus, by using different lengths 415, 416, 116, different spring stiffness can be achieved for the torsional springs 411, 412 and the torsional mirror springs 112-115; or, generally, different spring stiffness can be achieved for the elastic mount 111 and the torsional coupling 401-404.

Thereby, non-resonant, in-phase deflection of the torsional springs 411, 412 of the torsional couplings 401, 402 upon actuation of bending piezoelectric actuators 310, 320 can be implemented; while resonant or semi-resonant actuation of the mirror springs 112-115 is implemented. Resonant effects including non-linear effects are avoided for the torsional couplings 401-404.

For example, the torsional eigenmode of the mass-spring system formed by the (i) torsional-springs 411, 412 (spring) and (ii) the base 141, the elastic mount 111, and the mirror 150 (mass) can have a first eigenfrequency. The torsional eigenmode of the mass-spring system formed by the (i) torsional mirror springs 112-115 of the elastic mount 111 (spring) and (ii) the mirror 150 (mass) can have a second eigenfrequency. The first eigenfrequency may at least be 1.3× larger than the second eigenfrequency, optionally at least 1.5× larger. Thereby, the control signal 179 can be tuned to the second eigenfrequency.

Also, the length 415, 416 of the torsional springs 411, 412 can be tailored to the stroke length 399A of the piezoelectric actuators 310, 320. For example, the ratio between (i) the aggregate length 415, 416 of the torsional springs 411, 412 of each coupling 401-402 and (ii) the stroke length 399A can be in the range of 50:1 to 100:1. This helps to efficiently translate the quasi-linear deflection 399 of the piezoelectric actuators 310, 320 along the y-direction into the rotation of the base 141 in the xy-plane (cf. FIG. 8 and FIG. 5), i.e., around the z-axis.

Further, the deflection 399 of the piezoelectric actuators 310, 320—upon receiving the control signal 179—is along the y-direction (cf. FIG. 5). The quasi-linear motion is translated into the rotation of the base 141 by tailoring the spring stiffness of the torsional springs 141, 142 appropriately. For example, the flexure of the torsional springs 411, 412 along the y-direction is associated with a comparably large spring stiffness, in particular if compared to the spring stiffness associated with torsion of the torsional springs 411, 412 around the z-axis. For example, to provide a sufficient stiffness against flexure along the y-axis, the spring stiffness of flexure along the y-axis may be at least 2-5 times larger than the spring stiffens of torsion around the z-axis. This helps to efficiently translate the quasi-linear deflection 399 of the piezoelectric actuators 310, 320 along the y-direction into the rotation of the base 141 in the xy-plane (cf. FIG. 8 and FIG. 5), i.e., around the z-axis.

As a general rule, it would be possible that a cross-sectional area of each one of the torsional springs 411, 412 of the torsional couplings 401-404 is in the range of 80%-120% of a cross-sectional area of each one of the mirror springs 112-115.

FIG. 10 also illustrates a width 450 of the torsional springs 411, 412. The torsional springs 411, 412 can have a rectangular or square cross section. Typically, the width 450 may be in the range of 50 μm to 250 μm. For example, a cross-section of each one of the torsional springs 411, 412 may be in the range of 70 μm×70 μm to 130 μm×130 μm. For example, a ratio between the length 415, 416 and the width 450 can be in the range of 20:1 to 100:1.

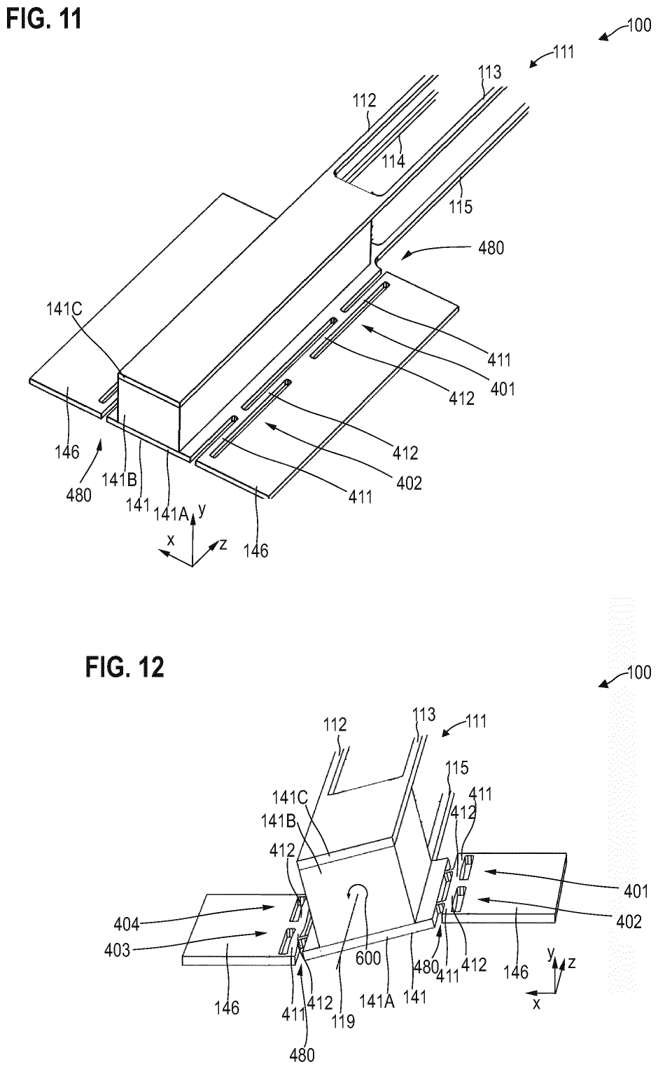

FIGS. 11 and 12 illustrate aspects with respect to torsional couplings 401-404 between the interface elements 146. FIGS. 11 and 12 are perspective views of the scan unit 100 including the torsional couplings 401-404 according to FIG. 10. Here, FIG. 11 illustrates a rest position of the torsional couplings 401-404 (in FIG. 11 the torsional couplings 403, 404 are obstructed from view); while FIG. 12 illustrates a state in which the torsional springs 411, 412 of the torsional couplings 401, 402 are deformed. The rotation 600 is illustrated.

FIGS. 11 and 12 also illustrate aspects with respect to the base 141. As illustrated, the base 141 includes a bottom part 141A; the bottom part 141A is integrally formed with the torsional couplings 401-404 and the interface elements 146. The bottom part 141A, the interface elements 146 and the torsional couplings 401-404 all extend in a common plane (xy-plane). The base can be fabricated from a common wafer. The base 141 also includes a center part 141B and a top part 141C.

It would be possible that the mirror springs 112, 113 are integrally formed with the top part 141C. The mirror springs 114, 115 are integrally formed with the bottom part 141A—and as such with the elastic couplings 401-404.

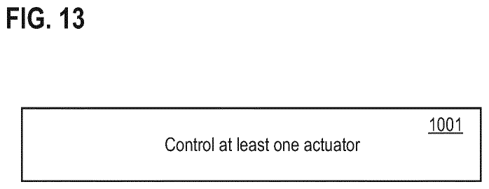

FIG. 13 is a flowchart of a method according to various examples. For example, the method of FIG. 13 may be executed by the control device 171.

At block 1001, one or more actuators are controlled, e.g., by outputting a control signal. The control signal may be an analog signal.

The one or more actuators are controlled such that an eigenmode of an elastic mount is resonantly or semi-resonantly excited. More specifically, an eigenmode of a mass-spring system formed by the elastic mount and a mirror attached to the elastic mount is excited. For example, a torsional eigenmode may be excited. Alternatively or additionally, a transversal eigenmode—sometimes also referred to as flexure—may be exited.

For this, one or more frequency components of the control signal may be appropriately set, i.e., within the resonance peak of the respective motional degree of freedom of the elastic mount.

The excitation can be via an elastic coupling. The elastic coupling may be configured to provide a shape-induced elasticity. The elastic coupling may be a torsional elastic coupling, cf. FIG. 10-12, torsional couplings 401-404.

By means of the torsional elastic coupling, a linear motion can be translated into a rotational motion (cf. FIG. 8, stroke 399A along y-axis and rotation around z-axis).

The deflection of the elastic coupling may be non-resonantly. Hence the one or more frequency components of the control signal may be outside a resonance peak of any motional degree of freedom of the elastic coupling. Thereby, one or more springs of the elastic coupling may have a different spring stiffness than one or more springs of the elastic mount.

Summarizing, techniques with respect to elastic hinges used to deflect a base of one or more mirror springs have been described. The elastic hinges can be T-shaped. The elastic hinges can include one or more torsional springs.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

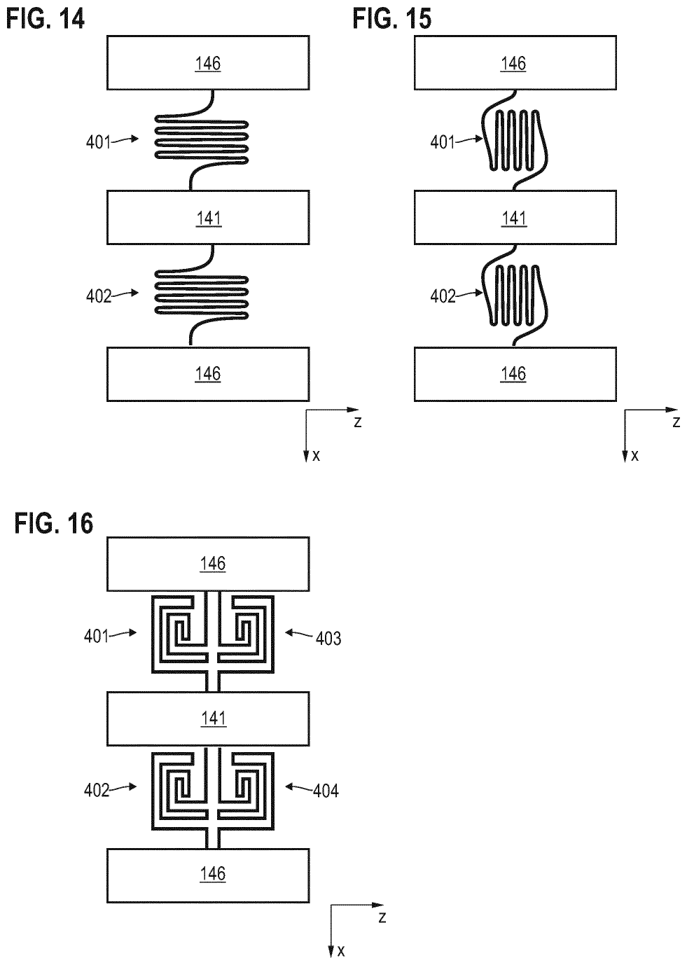

For illustration, above, various examples have been described in which a torsional coupling is provided that includes one or more torsional springs. However, in other examples, it would also be possible to provide a elastic coupling that employs springs configured to deflect transversally, e.g., leaf springs, etc. Such examples are illustrated in FIG. 14 and FIG. 15. Other configurations of springs of the elastic coupling are conceivable, e.g., 2-D configurations, cf. FIG. 16. Spiral-shaped springs could be used.

For further illustration, above, various examples have been described in which two bending piezoelectric actuators are employed. In other examples, other types of piezoelectric actuators may be employed. Also, it would be possible to employ a single actuator on one side of the base and fix the other side of the base.

For still further illustration, above, various scenarios have been described in which mirror springs of the elastic mount extend out-of-plane with respect to the mirror. In other examples, the mirror springs may extend in-plane with respect to the mirror.

1. A scan unit, comprising:
a base,
an elastic mount having a first end and a second end, the first end coupled to the base, the second end being configured to couple to a mirror,
at least one interface element configured to couple to one or more actuators, and
at least one elastic coupling arranged in-between the base and the at least one interface element and configured to deflect the base upon actuation of the one or more actuators,
wherein the at least one elastic coupling is integrally formed with at least a part of the base and the at least one interface element.

2. The scan unit of claim 1,
wherein each elastic coupling of the at least one elastic coupling comprises one or more torsional springs.

3. The scan unit of claim 2,
wherein each elastic coupling of the at least one elastic coupling comprises two torsional springs having a common first end coupled to the base and having separate second ends coupled to the respective interface element of the at least one interface element.

4. The scan unit of claim 2,
wherein the base and each interface element of the at least one interface element are arranged to form a respective gap,
wherein each torsional spring of the one or more torsional springs is arranged in and aligned with the respective gap.

5. The scan unit of claim 2,
wherein a ratio between a length of each torsional spring of the one or more torsional springs and a width of the one or more torsional springs is in the range of 20:1 to 100:1.

6. The scan unit of claim 2,
wherein the elastic mount comprises one or more torsional mirror springs,
wherein a length of the one or more torsional springs of the at least one coupling is in the range of 20% % of a length of the one or more torsional mirror springs of the elastic mount, optionally in the range of 30%-50%.

7. The scan unit of claim 1,
wherein the elastic mount comprises one or more torsional mirror springs,
wherein the at least one elastic coupling is configured to rotate the base upon actuation of the one or more actuators, to thereby excite a torsional eigenmode of a mass-spring system formed by the elastic mount and the mirror.

8. The scan unit of claim 2,
wherein the elastic mount comprises one or more torsional mirror springs,
wherein the at least one elastic coupling is configured to rotate the base upon actuation of the one or more actuators, to thereby excite a torsional eigenmode of a mass-spring system formed by the elastic mount and the mirror
wherein a longitudinal axis of the elastic mount and a longitudinal axis of the one or more torsional springs enclose an angle of not more than ±20° with respect to each other.

9. The scan unit of claim 1,
wherein the at least one interface element comprises a first interface element and a second interface element arranged on opposite sides of the base,
wherein the at least one elastic coupling comprises one or more first elastic couplings arranged in-between the base and the first interface element,
wherein the at least one elastic coupling comprises one or more second elastic couplings arranged in-between the base and the second interface element.

10. The scan unit of claim 1,
wherein a spring stiffness of the elastic mount is different from a spring stiffness of the at least one elastic coupling.

11. The scan unit of claim 1,
wherein a torsional eigenfrequency of a mass-spring system including (i) a spring formed by the elastic mount and (ii) a mass formed by the mirror is at least 1.5 times larger than a further torsional eigenfrequency of a further mass-spring system including (i) a further spring formed by the at least one elastic coupling and (ii) a further mass formed by the base, the elastic mount, and the mirror

12. A system, comprising:
the scan unit of claim 1, and
the one or more actuators coupled to the at least one interface element of the scan unit.

13. The system of claim 12, further comprising:
a control unit configured to output a control signal to the one or more actuators which results in non-resonant deflection of the at least one elastic coupling and in resonant or semi-resonant deflection of the elastic mount.

14. The system of claim 13,
wherein the one or more actuators comprise one or more piezoelectric actuators,
wherein the control unit is configured to set the control signal to cause a deflection of the piezoelectric actuators by a stroke length,
wherein the elastic mount comprises one or more torsional mirror springs,
wherein a ratio between a length of the one or more torsional springs of the at least one coupling and the stroke length is in the range of 50:1 to 100:1.

15. The system of claim 12,
wherein the one or more actuators comprise one or more piezoelectric actuators configured to deflect along a stroke direction upon receiving the control signal,
wherein a spring stiffness of flexure of the at least one elastic coupling along a direction parallel to the stroke direction is larger than a spring stiffness of torsion of the at least one elastic coupling around a direction perpendicular to the stroke direction.

16. A method, comprising:
controlling at least one actuator to resonantly or semi-resonantly deflect an elastic mount of a scanning mirror by non-resonantly deflecting at least one elastic coupling.

17. The method of claim 16,
wherein a linear motion of the at least one actuator is used to deflect the at least one elastic coupling,
wherein the elastic coupling translates the linear motion into a rotational motion of a base of the elastic mount.
